(19) United States
(12) Patent Application Publication
(10) Pub. No.: US 2006/0162486 A1
(43) Pub. Date: Jul. 27, 2006

(54) Pedal assembly

(76) Inventor: Eric B. Demmers, Wayne, NJ (US)

Correspondence Address: Robert Cannuscio;Drinker Biddle & Reath LLP, One Logan Square, 18th & Cherry Streets, Philadelphia, PA, 19103-6996, US

(21) Appl. No.: 11/044,130

(22) Filed: Jan. 27, 2005

(51) Int. Cl. G05G 1/14

(52) U.S. Cl. 74/560

(57) ABSTRACT

A pedal safety apparatus attached to a pedal assembly in a vehicle for restricting objects from becoming lodged between the pedal and the floor. The safety apparatus includes an assembly bracket attached to the floor surface for securing the assembly bracket to the floor surface. An upper attachment portion is attached to a bottom surface of the pedal for securing the upper attachment portion to the pedal. A boot is secured to the upper attachment portion and the assembly bracket and is resiliently compressible when the pedal is translated toward the floor.

### FIELD OF THE INVENTION

The present invention relates to braking systems and, more particularly, to a brake pedal apparatus for inhibiting and/or preventing items from becoming lodged under the pedal.

### BACKGROUND OF THE INVENTION

In recent years, little improvement has been undertaken to provide a pedal apparatus that would protect a potentially dangerous area beneath a moving pedal, such as a brake or clutch pedal. Many recent deaths have been blamed on objects becoming lodged beneath the brake pedal in both commercial and personal vehicles. See, for example, “Coffee mug jammed brakes”, New York Times, Jun. 1, 2004 article. To this day, current pedal assembly designs do not offer any protection to the potentially dangerous area that resides beneath the pedals. The direction of many recent inventions target the structural design in keeping the brake pedal from seizing or immobilizing during a vehicular accident. See, for example, U.S. Pat. No. 5,632,184. Attempts to replace the mechanics of a brake system and incorporate electronics have also been made. See, for example, U.S. Pat. No. 6,033,039. Improvements have also be made to redesign the area around the pedal assembly to increase the functionality of existing pedal assemblies, as well as configuring the assemblies for easy installation. See, for example, U.S. Pat. No. 5,829,317.

As is apparent from the above discussion, much of the work that has occurred in recent years to pedal designs has not been directed to preventing items from becoming lodged underneath the pedal. A need, therefore, exists for an improved pedal design that inhibits such dangerous occurrences.

### SUMMARY OF THE INVENTION

The present invention is directed to a pedal safety apparatus for incorporation into a conventional pedal assembly. It is a further object of the present invention to provide a pedal apparatus that will protect the potentially dangerous zone beneath a pedal assembly.

The utility of the pedal safety apparatus will serve to restrict objects from becoming lodged between a pedal and the floorings beneath the pedal. The apparatus is designed to not cause any excess or additional resistance when attempting to compress the pedal. The apparatus preferably has no mechanically moving parts. Due to the unreliability and cost factor, the apparatus will not utilize any electronics. It is designed to serve the primary purpose of inhibiting objects from becoming lodged beneath a moving pedal, by creating a barrier, so as to make this potentially dangerous area inaccessible.

The foregoing and other features and advantages of the present invention will become more apparent in light of the following detailed description of the preferred embodiments thereof, as illustrated in the accompanying figures. As will be realized, the invention is capable of modifications in various respects, all without departing from the scope of the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown. The drawings are not necessarily to scale, emphasis instead being placed on illustrating the principles of the present invention.

FIG. 1 is a front view of one embodiment of the present invention showing the pedal safety apparatus in an uncompressed state;

FIG. 2 is a side view of the pedal safety apparatus of FIG. 1;

FIG. 3 is an isometric view of the pedal safety apparatus of FIG. 1 installed on a pedal assembly;

FIG. 4 is a side view of a pedal assembly with the pedal safety apparatus installed and in its uncompressed state;

FIG. 5 is a side view of the pedal assembly of FIG. 4 illustrating the pedal safety apparatus in its compressed state; and

FIG. 6 is a side view of the pedal assembly illustrating the movement of the pedal during operation.

### DETAILED DESCRIPTION OF THE INVENTION

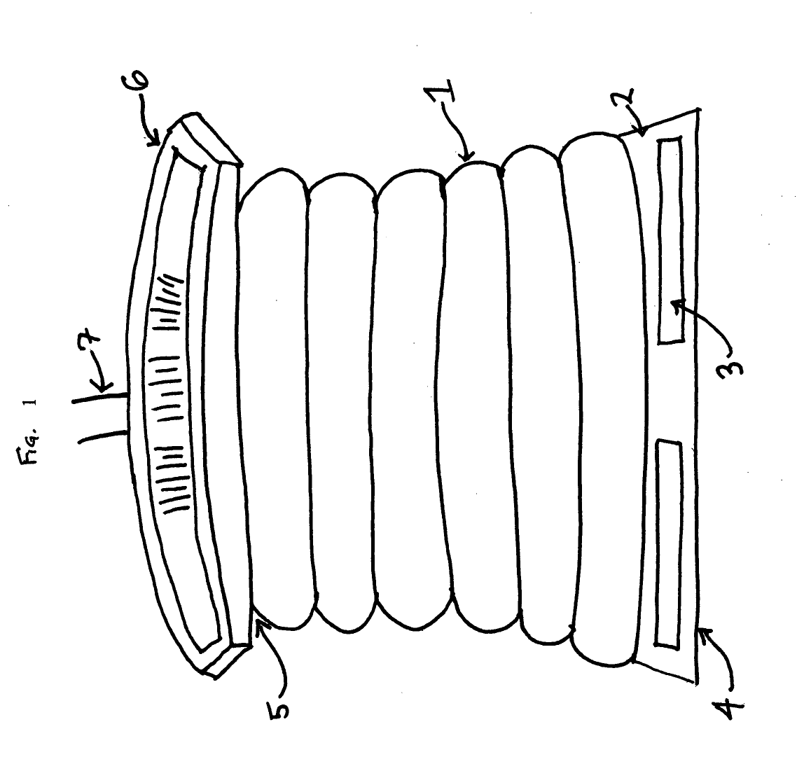

To describe the present invention more in detail, an embodiment of the present invention will be described below with references made to the drawings below. Referring to FIGS. 1-6, a pedal safety apparatus according to the present invention is illustrated and designed to operate when used in collaboration with any device, machine or vehicle that incorporates a pedal assembly.

The pedal safety apparatus includes a collapsible boot 1, preferably made from a strong, durable, flexible/resilient, rubber-like or a breathable material. Those skilled in the art would readily appreciate that various other materials can be used in the present invention in place of rubber. The boot 1 is preferably formed with circumferential ribs or pleats similar in look to a bellows. The pleats permitting controlled compression of the boot. The pedal safety apparatus' boot 1 is securely adhered or attached to an upper mounting bracket or directly to a conventional pedal 6. Preferably the attachment is provided by attaching an adhesion area 5 to the bottom surface of the pedal 6 through use of an adhesive. Other forms of attachment may be used. For example, a VELCRO hook and loop type fastener may be used to releasably attach the boot 1 to the pedal 6. (VELCRO is a trademark of Velcro, Inc.) The boot 1 may alternatively be fastened to the pedal 6 using any conventional fastener, such as a screw.

The pedal safety apparatus' boot 1 is securely attached to a lower mounting bracket or base 2. The base 2 includes air vents 3. As will become apparent below, the vents 3 allow for proper venting of fluids, such as gasses, from within the boot 1 in order to ensure that no excess resistance is caused when compression of the pedal 6 and its support arm 7 is performed. While the illustrated embodiment includes air vents 3 in the base 2, it is also contemplated that the boot 1 could be made from a breathable material or include vents so as to permit venting of air from the boot.

The incorporation of a flexible boot 1 is intended to provide a protective shield without interfering with the normal operation of a pedal assembly or changing a user's driving habits. The base 2 is securely attached to the floor 11 or flooring below the pedal 6. Preferably the attachment is provided by attaching an adhesion area 4 to the floor 11 through use of an adhesive. Other forms of attachment may be used. For example, a VELCRO-type hook and eye fastener may be used to releasably attach the base 2 to the floor 11. The base 2 may alternatively be fastened to the floor 11 with conventional fasteners, such as nut and bolt combination or screws.

It is also contemplated that the pedal safety apparatus of the present invention can be formed as part of the conventional pedal assembly. For example, brackets may be formed on the bottom of the pedal 6 onto which the boot 1 is clipped or snapped, The boot 1 of the present invention can be attached to the pedal 6 and/or the pedal support arm 7 of the device, machine or vehicle or the boot 1 can be molded to fit around the pedal 6 so as to essentially form one unit.

When reference is made to the term compression with respect to the pedal, it is referring to the actuation or depression of the pedal 6 towards the floor of the device, machine or vehicle, whether the movement is a pivoting of the pedal support arm 7 about its mounting point to the vehicle or a vertical downward motion of the pedal itself to the floor caused by the application of pressure to the pedal 6. When reference is made to the pedal assembly, it refers to the combination of the pedal 6 and the pedal support arm 7.

The purpose that the present invention will serve is to protect the potentially hazardous area beneath the pedal assembly. This area includes any region wherein an object could become lodged or stuck between a pedal and the flooring 11 beneath. The present invention will perform this task by inhibiting access to the vacant space between the pedal 6 and the floor 11.

FIG. 1 illustrates a front view of the pedal safety apparatus. It presents a detailed view of the boot 1, base 2, air vents 3, upper mounting bracket/attachment area 5, lower attachment area 4, pedal 6 and the pedal support arm 7. This view is an example of an extended pedal before compression of the pedal has taken place. The pedal safety apparatus is preferably sized and shaped to extend or occupy the width and length of the area beneath the pedal 6. The operational area of the present invention includes any dimensions beneath the operational path of the pedal 6 from a decompressed state, to a fully compressed state.

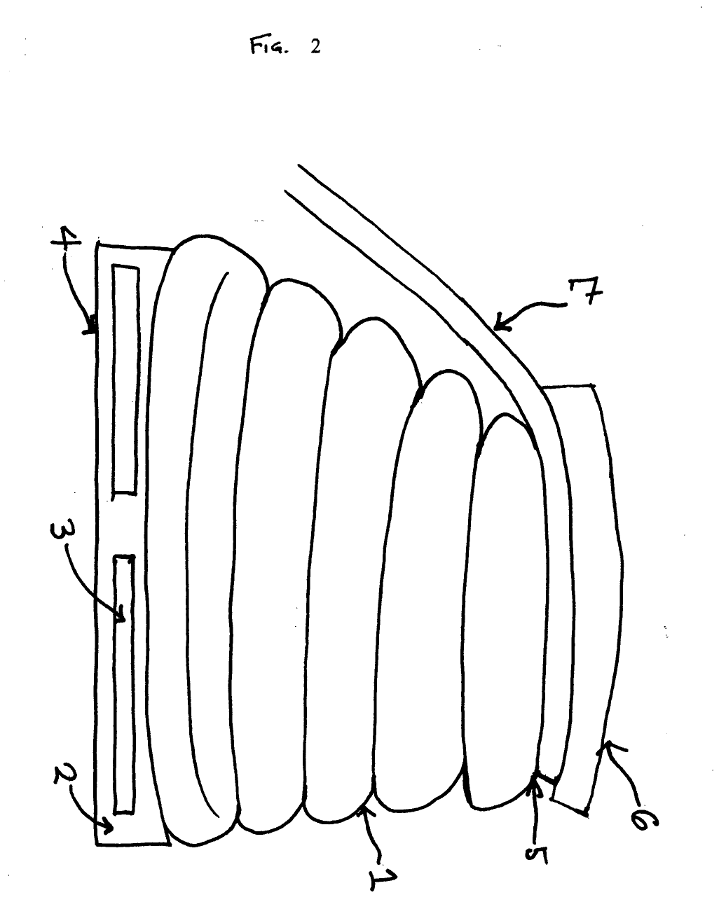

FIG. 2 illustrates a left side view of the pedal safety apparatus attached to the pedal assembly. It illustrates a detailed view of the boot 1, base 2, air vents 3, upper mounting bracket/attachment area 5, lower attachment area 4, pedal 6 and the pedal support arm 7. This view presents a better understanding of the vulnerable area that lies beneath the pedal assembly and how effortlessly a foreign object can become wedged within this potentially hazardous area.

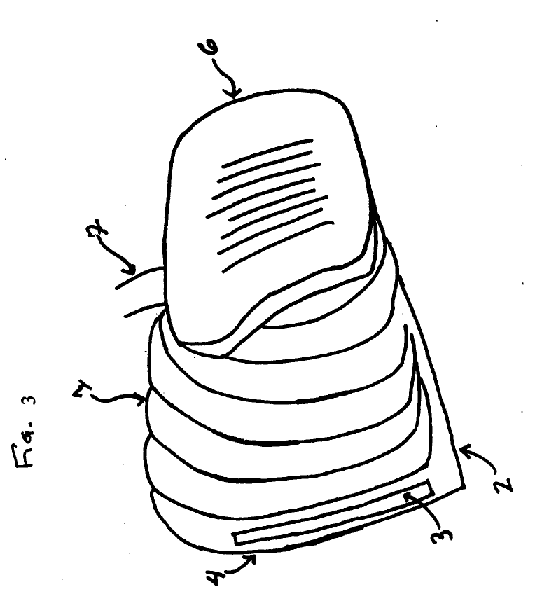

FIG. 3 is a perspective view of the apparatus. This view illustrates the boot 1, base 2, air vents 3, lower attachment area 4, pedal 6 and the pedal support arm 7. This view better demonstrates the coverage that the present invention is intended to provide. It illustrates protection throughout the complete operational area of the present invention including any dimensions beneath the operational path of the pedal 6 from a decompressed state, to a fully compressed state incorporating the length and width of the pedal 6 when either in a decompressed or compressed state.

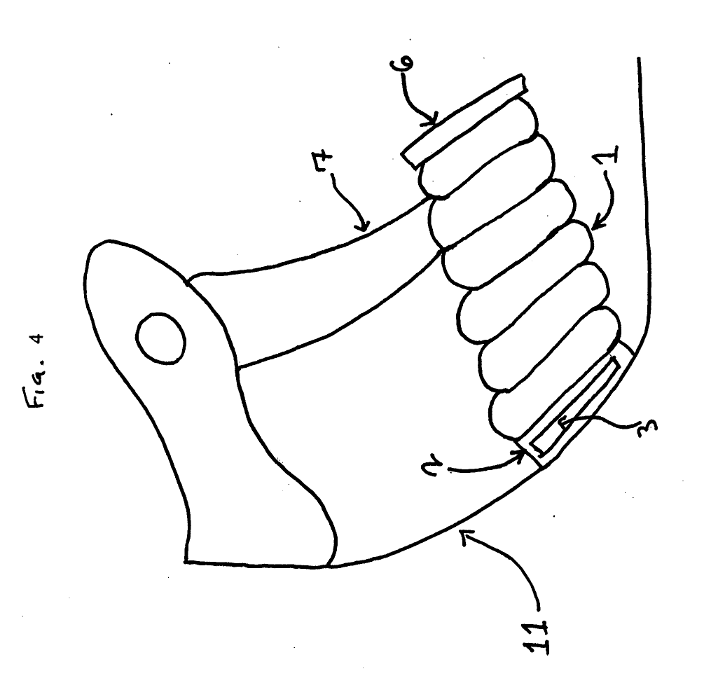

FIG. 4 is a side view of the pedal safety apparatus as it is intended for use in a vehicle. This view illustrates the pedal assembly in its uncompressed state and, in particular, shows the boot 1, base 2, air vents 3, pedal 6, pedal support arm 7 and the flooring 11 beneath the pedal assembly. This view entails a vivid image of how the apparatus can be positioned when installed in a conventional pedal assembly design.

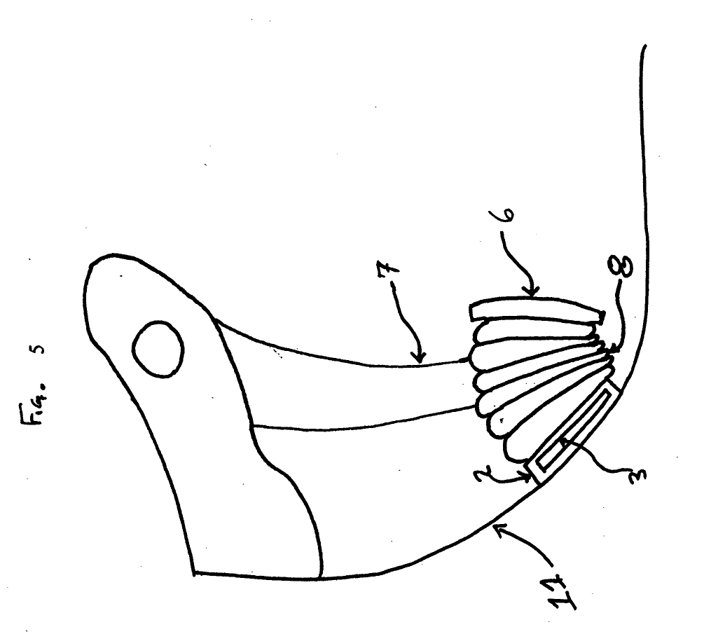

FIG. 5 is a side view similar to the view in FIG. 4 illustrating the compressed state of the pedal safety apparatus when the pedal assembly is compressed. It demonstrates a detailed view of the boot 1, base 2, air vents 3, pedal 6, pedal support arm 7 and the flooring 11 beneath the pedal assembly. This figure also demonstrates an example of how the present invention will appear in compressed state. The air vents 3 permit air to be expelled from within the boot during compression. The figure illustrates how the present invention protects the potentially hazardous area beneath the pedal 6.

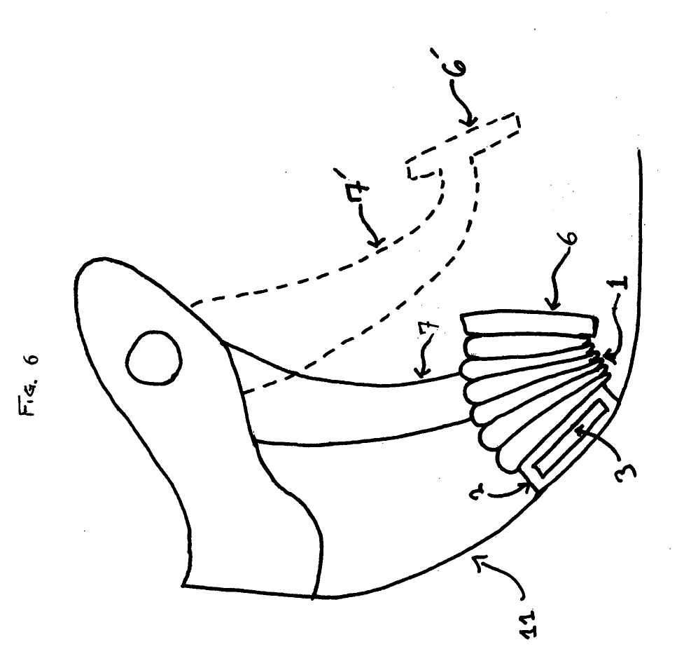

FIG. 6 illustrates the alternate positions of the pedal assembly. The illustration includes alternate uncompressed (in phantom) and compressed states of the base 2, 2′, air vents 3, 3′, floor 11, 11′, pedal 6, 6′ and pedal support arm 7, 7′. This view exemplifies the path that the pedal 6 takes when compressed in a downward motion towards the floor 11. The shown path outlines the potentially hazardous area that, if not protected by the pedal safety apparatus, could become obstructed by a foreign object.

The present invention may be embodied in other specific forms without departing from the spirit or essential attributes thereof and, accordingly, reference should be made to the appended claims, rather than to the foregoing specification, as indicating the scope of the invention.

What is claimed is:

1. A pedal safety apparatus for use in a device, machine or vehicle that includes a pedal which is translatable toward a surface, the safety apparatus comprising:
an assembly bracket attachable to a surface of a device, machine or vehicle for securing the apparatus to the surface;
an upper attachment portion attachable to a bottom surface of a pedal for securing the apparatus to the pedal; and
a boot secured to the upper attachment portion and the assembly bracket, the boot being resiliently compressible with little extra resistance when the pedal is translated toward the surface.

2. A pedal safety apparatus according to claim 1, wherein the pedal is located within a vehicle, the vehicle including a support structure onto which the pedal is pivotally mounted, and wherein the surface is a floor of the vehicle.

3. A pedal safety apparatus according to claim 1, wherein the boot is made from a durable rubber-like material.

4. A pedal safety apparatus according to claim 1, wherein the boot is made from a material with a portion being air permeable.

5. A pedal safety apparatus according to claim 1, further comprising vents formed in the assembly bracket for venting air from the boot.

6. A pedal safety apparatus according to claim 1, further comprising vents formed in the upper attachment portion for venting air from the boot.

7. A pedal safety apparatus according to claim 1, further comprising vents formed in the boot for venting air from the boot.

8. A pedal safety apparatus according to claims 1, wherein the apparatus is mounted within a vehicle, the vehicle having a pedal translatable from an un depressed state to a depressed state, the upper attachment portion being attached to a lower portion of the pedal, the assembly bracket being attached to a floor in the vehicle below the pedal, the boot occupying the region beneath the pedal, the boot inhibiting objects from lodging beneath the pedal.

9. A pedal safety apparatus according to claim 1, wherein the boot includes pleats to facilitate compression of the boot.

10. A pedal safety apparatus attached to a pedal assembly in a vehicle, the pedal assembly including a pedal attached to a pedal support, the peddle support being pivotally mounted to the vehicle such that the pedal is translatable toward a floor surface in the vehicle, the safety apparatus comprising:
an assembly bracket attached to the floor surface for securing the assembly bracket to the floor surface;
an upper attachment portion attached to a bottom surface of the pedal for securing the upper attachment portion to the pedal; and
a boot secured to the upper attachment portion and the assembly bracket, the boot being resiliently compressible when the pedal is translated toward the floor surface.

11. A pedal safety apparatus according to claim 10, wherein the boot is made from a durable rubber-like material.

12. A pedal safety apparatus according to claim 10, wherein at least a portion of the apparatus is permeable to air.

13. A pedal safety apparatus according to claim 12, wherein the air permeability is provided by vents formed in the assembly bracket for venting air from the boot.

14. A pedal safety apparatus according to claim 12, wherein the air permeability is provided by vents formed in the upper attachment portion for venting air from the boot.

15. A pedal safety apparatus according to claim 12, wherein the air permeability is provided by vents formed in the boot for venting air from the boot.

16. A pedal safety apparatus according to claim 10, wherein the boot includes pleats to facilitate compression of the boot.
